(19) United States
(12) Patent Application Publication
(10) Pub. No.: US 2014/0053385 A1
(43) Pub. Date: Feb. 27, 2014

(54) CARRIER FOR RELEASABLY SECURING AN OBJECT

(71) Applicants: Cole Nielsen-Cole, San Jose, CA (US); Patrick McCrone, Barboursville, VA (US)

(72) Inventors: Cole Nielsen-Cole, San Jose, CA (US); Patrick McCrone, Barboursville, VA (US)

(21) Appl. No.: 13/591,025

(22) Filed: Aug. 21, 2012

(51) Int. Cl. F16B 21/08

(52) U.S. Cl. 29/426.1; 403/326; 403/327

(57) ABSTRACT

A carrier for releasably securing an object, such as an ammunition magazine, a PDA, a mobile phone, an MP3 player, and the like, having a latching pin and an opposed biasing member. The latching pin is positioned on an interior wall of the housing of the carrier to mate with a corresponding aperture or the like formed on the interior surface of an object when the object is inserted in the carrier, to enable rapid insertion of the object into the carrier, to provide secure retention of the object in the carrier, and to enable the rapid and easy retrieval of the object from the carrier.

### FIELD OF THE INVENTION

The invention relates generally to carriers for releasably securing an object, such as an ammunition magazine, a PDA, a mobile phone, an MP3 player, and the like, and, more specifically, a carrier having a latching pin and an opposed biasing member. The latching pin is positioned within the carrier to mate with a corresponding aperture or the like formed on the interior surface of an object when the object is inserted in the carrier, to enable rapid insertion of the object into the carrier, to provide secure retention of the object in the carrier, and to enable the rapid and easy retrieval of the object from the carrier.

### BACKGROUND

Detents have long been used to releasably secure one object to another. In many cases, the detent comprises a latching pin formed on one object that is biased by a spring into an aperture, slot, or the like formed on the surface of a second object. In U.S. Pat. No. 5,462,380, for example, two tubes are secured together by a detent formed by a detent pin mounted on an inner tube which extends through openings in both the inner tube and an outer tube's walls when these openings are properly aligned. The detent pin is releasably held in place by a leaf spring attached to the detent pin. Pushing a button causes a countervailing force to be applied to the leaf spring to cause the detent pin to withdraw from the two openings, to thereby enable the two tubes to be separated.

An example of a carrier that uses a detent to releasably secure an object in the carrier is shown in U.S. Pat. No. 4,799,323. This patent discloses an ammunition magazine carrier which releasably holds the ammunition magazine securely in the carrier by means of a claw that is positioned to extend into a chamber formed by the carrier and to engage an aperture or slot (notch 102) formed on the surface of the magazine positioned in the chamber. The claw is biased by a spring to seat within the notch until the user moves a lever attached to the claw to apply a countervailing force that causes the claw to unseat and allow the magazine to be removed from the carrier.

An example of a carrier that uses either springs or friction blocks on each side of an object to secure the object in the carrier is shown in U.S. Patent Application Publication No. US 2010/0176174.

There is no known prior art reference, however, where a biasing member is on the opposite interior wall of the carrier from a latching pin for releasably securing an object positioned between these structures. Nor is there a carrier that enables an object secured in the carrier to be released by applying a twisting or torque force to the object. These and other distinguishing features of the various embodiments of the present invention are described below.

### SUMMARY OF INVENTION

The following summary of the invention is included in order to provide a basic understanding of some aspects and features of the invention. This summary is not an extensive overview of the invention and, as such, it is not intended to particularly identify key or critical elements of the invention or to delineate the scope of the invention. Its sole purpose is to present some concepts of the invention in a simplified form as a prelude to the more detailed description that is presented below.

Broadly stated, one embodiment of the invention is a carrier for releasably securing an object having an aperture or the like formed on one surface of the object, the carrier comprising: a housing having four walls and defining an opening at one end for receiving said object; a first biasing member positioned on the interior surface of one of said walls of said housing; and a first latching pin positioned on the interior surface of the wall of said housing opposite to the wall on which said first biasing member is positioned, said first latching pin operable to mate with said aperture when said object is inserted into the housing, said first biasing member operable to apply a constant force against the adjacent surface of said object to cause said first latching pin to seat in said aperture to releasably retain said object in said housing, a portion of said object extending from said housing when said object is releasably retained in said housing for enabling an external force to be applied to said object to counteract the force applied by said biasing member to enable disengagement of said first latching pin from the aperture and removal of said object from said housing.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale. The description herein makes reference to the accompanying drawings wherein like reference numbers refer to like parts throughout the several views.

FIG. 1 is a perspective view of a carrier with an object secured inside according to one embodiment of the invention.

FIG. 2 is a side view of the carrier and object shown in FIG. 1.

FIG. 3 is an end view of the carrier and object shown in FIG. 1.

FIG. 4 is a top view of the carrier and object shown in FIG. 1.

FIG. 5 is a side view of an object, e.g., a conventional ammunition magazine, having an aperture, slot, or the like formed in the surface of the object.

FIG. 6 is a cross-sectional view of the object shown in FIG. 5 taken along the line 6-6 in FIG. 5.

FIG. 7 is a perspective view of the object shown in FIG. 5.

FIG. 8 is a first perspective view of a carrier according to one embodiment of the invention.

FIG. 9 is a second perspective view of the carrier according to one embodiment of the invention.

FIG. 10 is a top view of the carrier shown in FIGS. 8 and 9.

FIG. 11 is a cross-sectional view of the carrier of FIG. 10 taken along the line 11-11 in FIG. 10.

FIG. 12 is a cross-sectional view of the carrier of FIG. 10 taken along the line 12-12 in FIG. 10.

FIG. 13 is a top view of another embodiment of a carrier with an object secured inside according to the invention.

FIG. 14 is a cross-sectional view of the carrier and object shown in FIG. 13 taken along the line 14-14 in FIG. 13, and FIG. 14A is a detailed view of one portion of FIG. 14.

FIG. 15 is a perspective view of the carrier of FIG. 13 with the object removed.

FIG. 16 is a top view of the carrier of FIG. 14.

FIG. 17 is a perspective view of a carrier according to one embodiment of the invention with inserts removed.

FIG. 18 is a top view of the carrier of FIG. 17.

FIG. 19 is a cross-sectional view of the carrier of FIG. 18 taken along the line 19-19 in FIG. 18.

FIG. 20 is an exploded view of the carrier of FIG. 8 showing how inserts are inserted into front wall of the housing of the carrier according to one embodiment of the invention.

FIG. 21 is an exploded view of the carrier of FIG. 9 showing how inserts are inserted into rear wall of the housing of the carrier according to one embodiment of the invention.

FIG. 22 is perspective view of the front of a latching pin insert according to one embodiment of the invention.

FIG. 23 is a perspective view of the back of the latching pin insert shown in FIG. 22.

FIG. 24 is a perspective view of the front of a biasing member insert according to one embodiment of the invention.

FIG. 25 is a perspective view of the back of the biasing member insert shown in FIG. 24.

FIG. 26 is a side view of the biasing member insert shown in FIG. 24.

### DETAILED DESCRIPTION

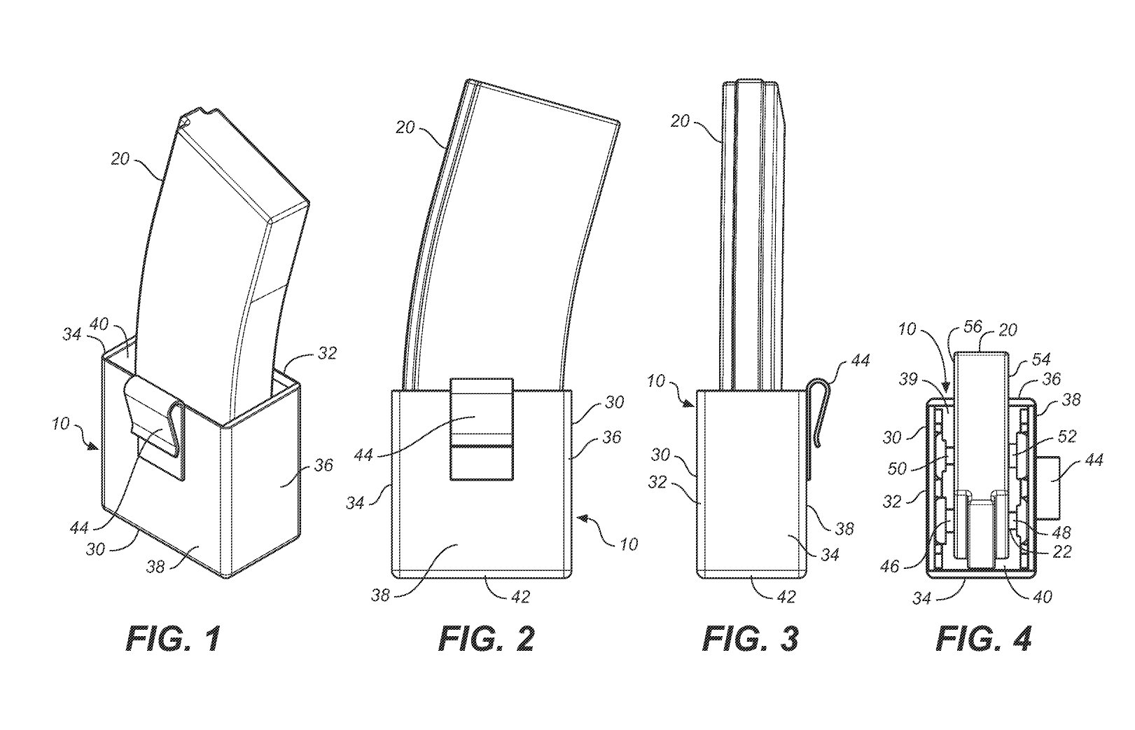

With reference initially to FIGS. 1-7, one embodiment of a carrier according to the invention is shown at 10. Carrier 10 functions to releasably secure an object 20 having an aperture or the like 22 formed on one surface 54 of the object 20. Carrier 10 includes a housing 30 having four walls, a front wall 32, two side walls 34 and 36, and a rear wall 38, walls 32-38 defining an interior chamber 39 with an opening 40 at one end of housing 30 for receiving said object 20. In one embodiment, housing 30 also includes a base 42 at the end of housing 30 opposite to opening 40. Also in the embodiment shown, carrier 20 includes a clip 44. Clip 44 is shaped to fasten carrier 20 onto a belt. Clip 44 can be any device for enabling the carrier 20 to be retained on a belt, vest, backpack, or the like, including a belt receiving slot, one or more straps or hooks, fingers for fitting into a Molle vest, etc.

Interior chamber 39 is sized to receive the object 20 to be secured in carrier 10. For example, the carrier 10 can be sized, as shown in the figures, to releasably retain an ammunition magazine. Interior chamber 39 is sized such that a portion of the object 20 extends from housing 30 when the object is releasably retained in carrier 10.

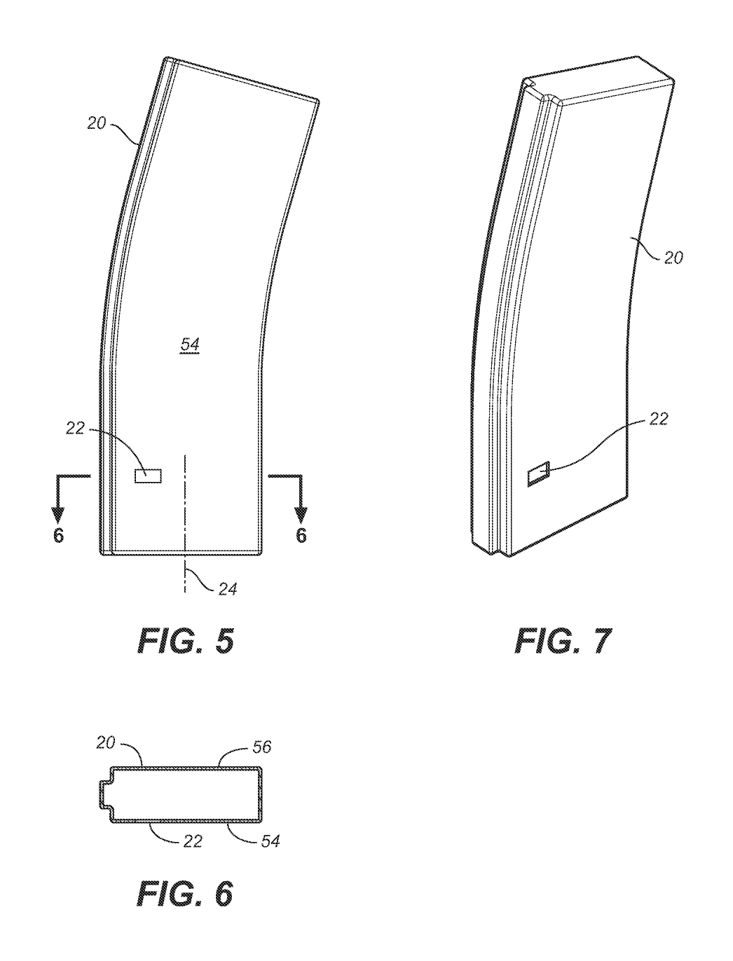

As best seen in FIG. 4, a first biasing member 46 is positioned on the interior surface of one of said walls of said housing 30. A first latching pin 48 is positioned on the interior surface of the wall of said housing 30 opposite to the wall on which said first biasing member is positioned. In the embodiment shown in FIG. 4, first biasing member 46 is positioned on the interior surface of front wall 32 and the first latching pin 48 is positioned on the interior surface of rear wall 38. Acting in conjunction with the aperture 22 formed on the object to be secured in housing 30, first latching pin 48 and first biasing member 46 act as a detent to hold the object 20 in a fixed location until it is released by a user of carrier 10. As seen in FIG. 4, both first latching pin 48 and first biasing member 46 are positioned on one side of the center of interior chamber 39 and closer to side wall 34. This is because the aperture 22 of object 20 is preferably offset from the axis of insertion and removal of the object 20 from carrier 10, shown at 24 in FIG. 5. In order to be able to mate with aperture 22, the first latching pin 48 is offset the same distance from the center of interior chamber 39. The first biasing member 46 is also positioned a predetermined distance from the axis of insertion of said housing so that, when the object 20 is being retained in carrier 10, a twisting or torque force applied to the adjacent surface of object 20 in the opposite direction to the torque applied to object 20 by said first biasing member enables removal of object 20 from housing 30. In other words, to release object 20, a user grips the portion of object 20 that extends out from the housing 30 and applies a twisting or torque force to the object 20 in a direction that counteracts the constant force applied to the object 20 by first biasing member 48, to remove the first latching pin 48 from aperture 22. The user then is enabled to withdraw the object 20 from housing 30.

As also seen in FIG. 4, opposed blocks or spacers 50 and 52 are preferably also positioned on the interior surfaces of front wall 32 and rear wall 38, respectively. These spacers are sized to provide support for the object 20 at two other points in interior chamber 39 besides the points where the first biasing member 46 and first latching pin 48 are contacting the object 20, when the object 20 is being secured in housing 30 by these other components. In one embodiment, spacers 50 and 52 are positioned on the other side of the center of interior chamber 39 from the first latching pin 48 and first biasing member 46 and closer to side wall 36. In another embodiment, the interior walls 32 and 38 of housing 30 can be shaped to provide structural support for object 20 to better retain object 20 in housing 30 without rattling or other movement while latching pin 48 is mated with aperture 22 of object 20.

FIGS. 5-7 illustrate one exemplary aperture for the object that is retained in carrier 10. As seen in FIG. 5, in this ammunition magazine example, the aperture 22 is a hole formed in a side surface 54 of object 20. The first latching pin is positioned on wall 38 where it is operable to mate with said aperture 22 when object 20 is inserted into the housing 30. The first biasing member 46 is operable to apply a constant force against the opposite side surface 56 of object 20, to cause said first latching pin to seat in said aperture 22 to releasably retain object 20 in housing 30. FIG. 6 is a cross-sectional view of the object 20 shown in FIG. 5 taken along the line 6-6 in FIG. 5 and FIG. 7 is a perspective view of the object 20 shown in FIG. 5. FIG. 6 illustrates the two side surfaces 54, 56 of object 20 and the aperture 22 formed in side surface 54.

It is within the ordinary skill in the art for the aperture 22 to alternatively be a slot, a dimple, a cleft, a v-shaped indentation, or some other structure formed in or on the side surface 54 of object 20 that is shaped to mate with first latching pin 48. First latching pin 48 can also be any shape sufficient to act with the aperture 22 to provide a detent function.

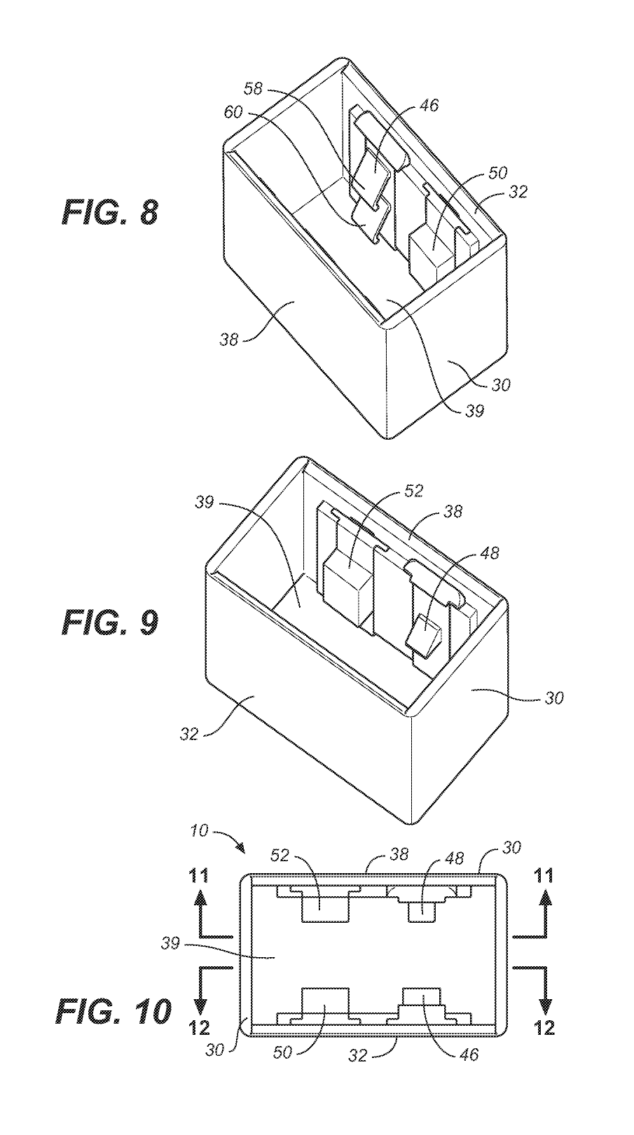

FIG. 8 is a first perspective view of a carrier 10 according to one embodiment of the invention with object 20 removed (and with clip 44 omitted for clarity). FIG. 8 is a first view of the interior chamber 39 and shows the interior of front wall 32 of housing 30. FIG. 9 is a second perspective view of the carrier 10 and interior chamber 39 according to one embodiment of the invention and shows the interior of wall 38 of housing 30 that faces wall 32. FIG. 10 is a top view of the carrier shown in FIGS. 8 and 9. As seen in FIG. 8, positioned on the interior surface of front wall 32 is the first biasing member 46. In one embodiment, biasing member 46 comprises two leaf or cantilever springs 58 and 60 positioned one above the other that extend out into interior chamber 39 from front wall 32. A benefit of two spaced apart leaf springs 58, 60 is that they provide a biasing force on object 20 at two different locations on the side surface 56 of object 20. As seen in FIG. 9, positioned on the interior surface of rear wall 38 is the first latching member 48. FIG. 10 shows that the first biasing member 46 is positioned in this embodiment directly across interior chamber 39 from first latching pin 48. Spacers 50 and 52 are also shown in this embodiment, with spacer 50 positioned on wall 32 and spacer 52 positioned on wall 38. As best seen in FIG. 10, spacers 50 and 52 are positioned directly across interior chamber 39 from each other.

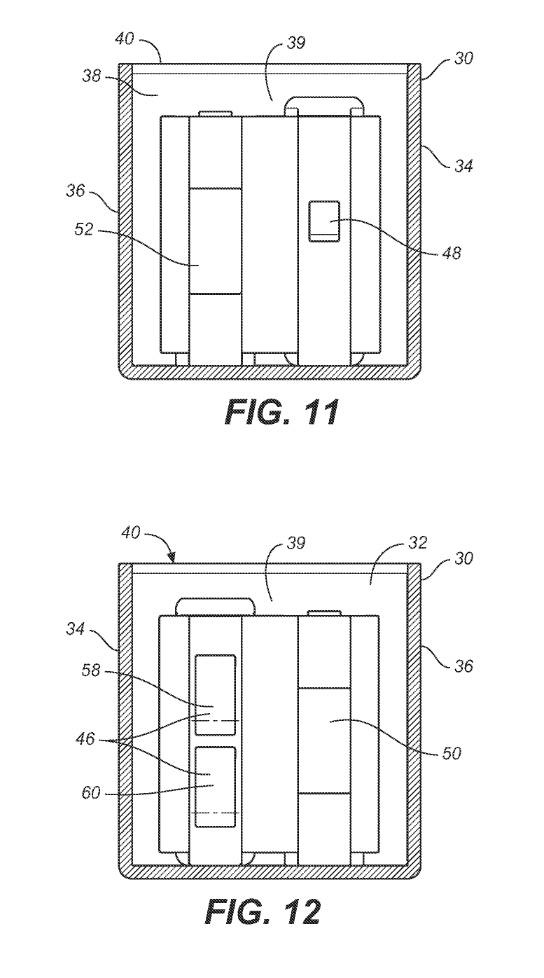

FIG. 11 is a cross-sectional view of the carrier of FIG. 10 taken along the line 11-11 in FIG. 10. FIG. 11 is a side view of rear wall 38 and shows the orientation of the first latching pin 48 and spacer 52 on the interior surface of wall 38 according to the embodiment of carrier 10 shown in FIGS. 9 and 10. FIG. 12 is a cross-sectional view of the carrier of FIG. 10 taken along the line 12-12 in FIG. 10. FIG. 12 is a side view of front wall 32 and shows the orientation of spacer 50 and biasing member 46, comprising leaf springs 58 and 60, on the interior surface of wall 32 according to the embodiment of carrier 10 shown in FIGS. 8 and 10.

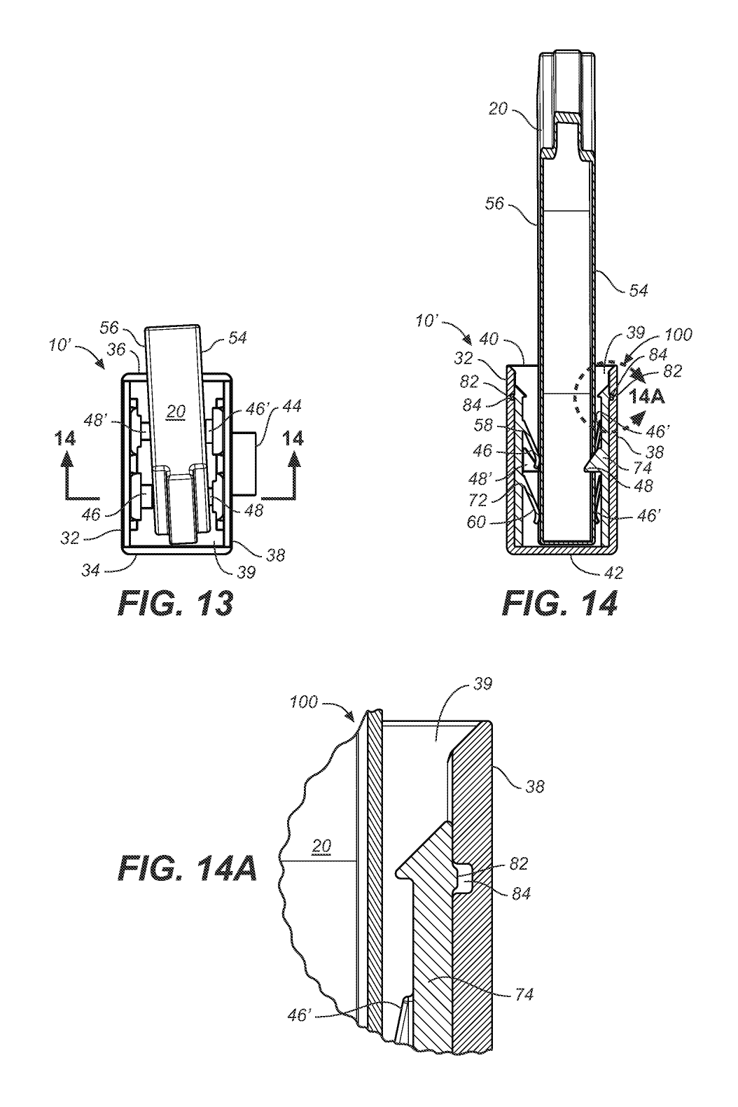

FIG. 13 is a top view of a carrier 10′ with an object 20 secured inside according to another embodiment of the invention. In the embodiment shown in FIG. 13, the spacers 50 and 52 are replaced with a second latching pin 48′ and a second biasing member 46′ on the walls opposite to the walls on which the first latching pin 48 and first biasing member 46 are positioned. As seen in FIG. 13, second latching pin 48′ is positioned on wall 32 and second biasing member 46′ is positioned on wall 38 opposite to second latching pin 48′. Second biasing member 46′ applies a constant force to the opposite side of object 20 from where the constant force from the first biasing member is applied. As seen in FIG. 13, first biasing member 46 applies a constant force against surface 56 of object 20, while second biasing member 46′ applies a constant force against surface 54 of object 20. In one example of object 20, there is no aperture adjacent where second latching pin 48′ is positioned. Consequently, the constant force applied by second biasing member 46′ causes the surface 56 of object 20 to be held against second latching pin 48′. The result is that second biasing member 46′ and second latching pin 48′ provide at least two additional points of contact on the surfaces of object 20 to increase the holding force on object 20 as well as to lessen the tendency of object 20 to wobble or rattle in housing 30. As also seen in FIG. 13, object 20 may seat in interior chamber 39 in a slightly offset orientation with respect to its axis of insertion 24 as a function of the operation of the detent comprising the seating of first latching pin 48 in aperture 22 as a function of the force applied by biasing member 46.

FIG. 14 is a cross-sectional view of the carrier 10′ and object 20 shown in FIG. 13 taken along the line 14-14 in FIG. 13 (with clip 44 omitted for clarity). As seen in FIG. 14, object 20 is retained in carrier 10′ through the mating or seating of first latching pin 48 in aperture 22. First latching pin 48 is retained in aperture 22 due to the constant force applied on surface 56 of object 20 by first biasing member 46. As seen in this embodiment, with first biasing member 46 comprising two spaced apart leaf springs 58 and 60, these leaf springs contact surface 56 of object 20 at two different points. This spaces apart the applied holding force on object 20 to further increase the stability of the retention of object 20 in carrier 10′.

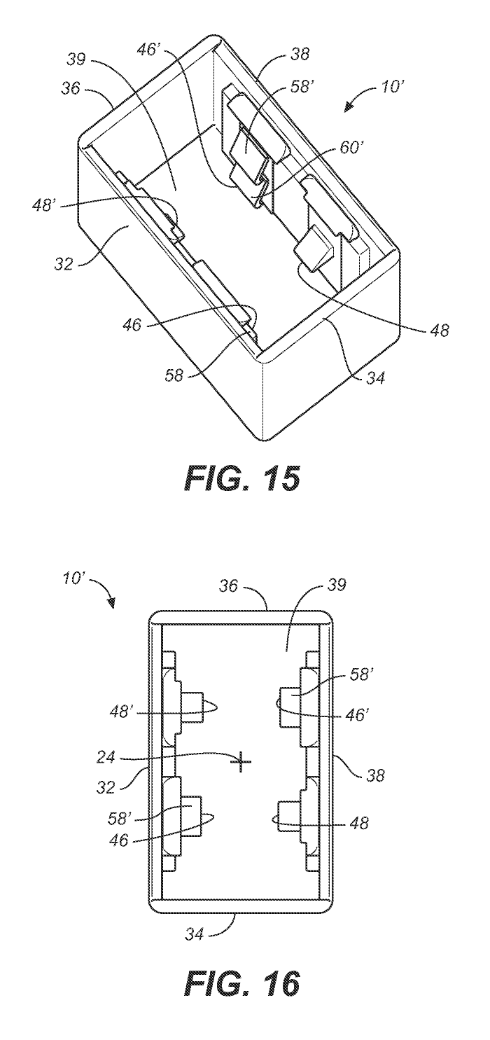

FIG. 15 is a perspective view of the carrier 10′ of FIG. 13 with the object removed. FIG. 15 illustrates the respective positions of the first and second latching pins 48 and 48′ and the first and second biasing members 46 and 46′. In one embodiment, as shown, both the first and second biasing members include two leaf springs, with first biasing member 46 having leaf springs 58 and 60 and second biasing member 46′ having leaf springs 58′ and 60′. As perhaps best seen in this figure, the carrier 10′ embodiment provides a plurality of points of contact on the surfaces 54 and 56 of an object 20, to better releasably retain object 20 in carrier 10′. These contact points including two contact points by the two leaf springs 58 and 60 of first biasing member 46 and two contact points by the two leaf springs 58′ and 60′ of second biasing member 46′. First latching pin 48 and second latching pin 48′ provide two additional contact points on object 20, with first latching pin mating in aperture 22 and second latching pin 48′ contacting surface 56 of object 20.

FIG. 16 is a top view of the carrier 10′ of FIG. 13 with object 20 removed. FIG. 16 illustrates the position of the two biasing members 46 and 46′ and the two latching pins 48 and 48′ in internal chamber 39 and with respect to the axis of insertion 24 of object 20. As also seen in the carrier 10′ embodiment shown inn FIG. 16, the placement of the second latching pin 48′ and second biasing member 46′ enables the object 20 to be inserted with surface 54 of object 20 facing the opposite wall 32 of carrier 10′. This enables the aperture 22 of object 20 to mate with second latching pin 48′ rather than first latching pin 48. In this orientation, second biasing member 46′ applies the necessary constant force to cause second latching pin 48′ to seat in aperture 22.

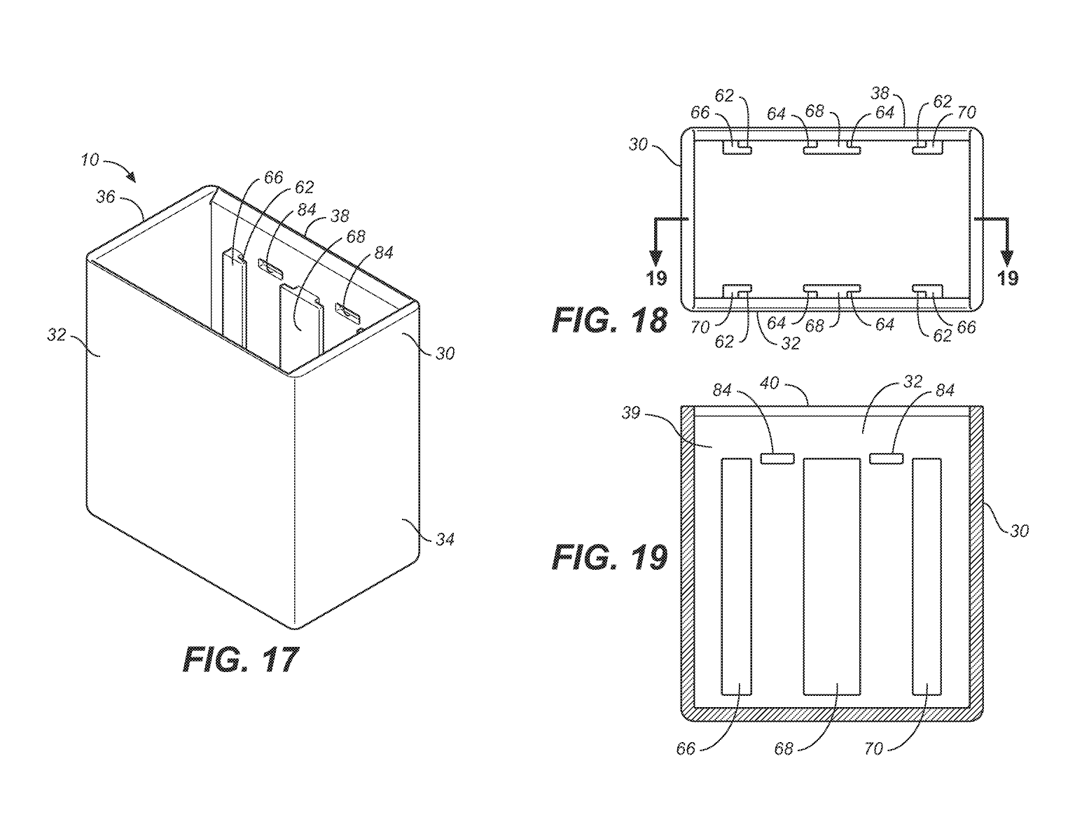

In a second alternate embodiment of a carrier 10, the first and second biasing members, first and second latching pins, and/or spacers 50 and 52, are separate inserts that are each removably fastened to the walls of housing 30. These inserts each have elongated fingers along each side of the inserts that fit in parallel tracks formed on the interior surfaces of walls 32 and 38. In the carrier 10 embodiment shown in FIGS. 8-10, the inserts comprise first latching pin 48, first biasing member 46, and spacers 50 and 52. In the carrier 10′ embodiment shown in FIGS. 13-16, the inserts comprise first and second latching pins 48 and 48′ and first and second biasing members 46 and 46′. FIG. 17 is a perspective view of a carrier according to one embodiment of the invention with its inserts removed. FIG. 18 is a top view of the carrier of FIG. 17, and FIG. 19 is a cross-sectional view of the carrier of FIG. 18 taken along the line 19-19 in FIG. 18. As best seen in FIG. 18, surfaces 32 and 38 of housing 30 each include two sets of opposed parallel tracks 62 and 64 formed by rails 66, 68 and 70. As described below, each insert is preferably retained in the tracks 62, 64 of walls 32, 38 by a detent comprising a ridge formed on the rear of each insert positioned to mate with a corresponding recess formed in the walls 32, 38. These detent recesses are best seen in FIGS. 17 and 19 at 84. As shown in these figures, each set of parallel tracks 62, 64 includes a recess 84 for releasably retaining an associated insert on a corresponding wall 32, 38.

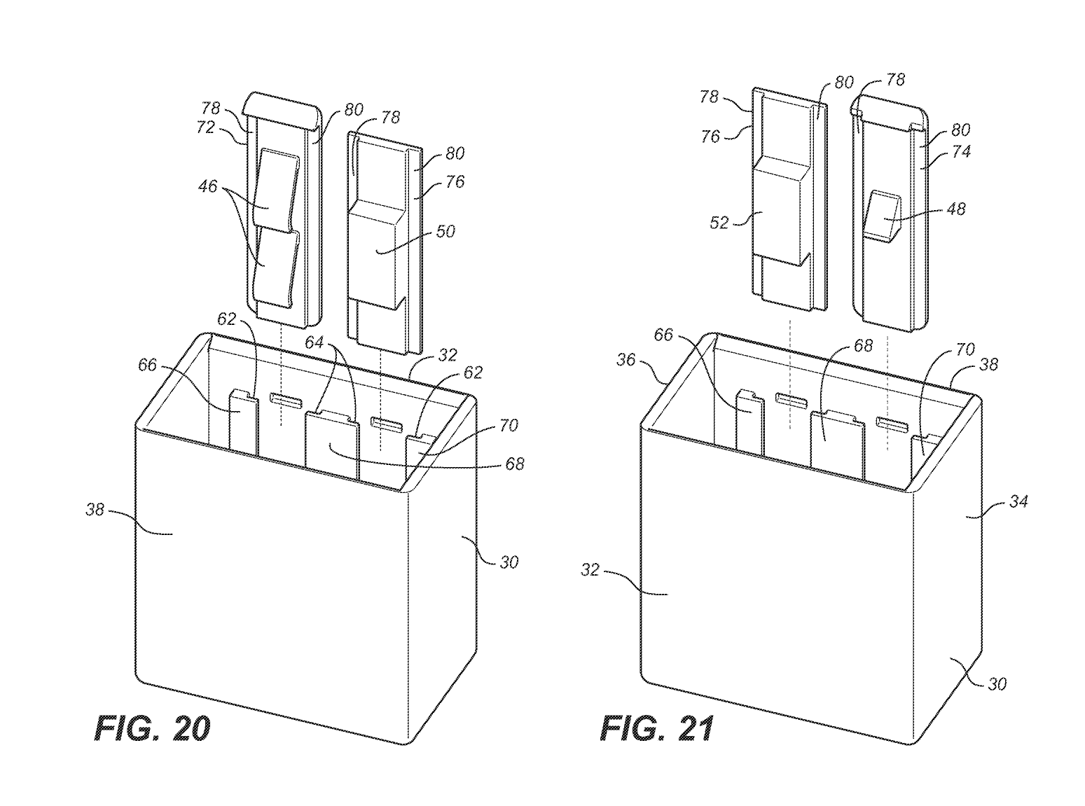

FIG. 20 is an exploded view of the carrier 10 of FIG. 8 showing how inserts are inserted into the tracks 62, 64 formed in the front wall 32 of the housing 30 of the carrier 10 according to one embodiment of the invention. FIG. 21 is an exploded view of the carrier of FIG. 9 showing how inserts are inserted into the tracks 62, 64 formed in the rear wall 38 of the housing 30 of the carrier 10 according to one embodiment of the invention. Referring first to FIG. 20, biasing member 46 is mounted on a biasing member insert 72. Similarly, each spacer 50, 52 is mounted on a spacer insert 76. Each insert includes elongated fingers 78 and 80. These fingers are sized to slidably fit within respective tracks 62 and 64 formed by rails 66, 68, and 70 in either front wall 32 or rear wall 38. As seen in FIG. 20, fingers 78 and 80 of biasing member insert 72 are sized to slidably fit in parallel tracks 62 and 64 formed respectively by rails 66 and 68 on wall 32.

Referring to FIG. 21, latching pin 48 is mounted on a latching pin insert 74. Each latching pin insert 74 also include elongated fingers 78 and 80 and are sized to slidably fit in parallel tracks 62 and 64 formed by rails 66, 68, and 70 in either front wall 32 or rear wall 38. As seen in FIG. 21, fingers 78 and 80 of latching pin insert 74 are sized to slidably fit in parallel tracks 62 and 64 formed respectively by rails 68 and 70 on wall 38.

Inserts 72, 74, and 76 are releasably retained on respective walls 32, 38 of housing 30 by a detent comprising a ridge 82 formed on each insert 72, 74, and 76 positioned to mate with a retaining recess 84 formed in the walls 32, 38. As seen in FIGS. 19 and 20, two recesses 84 are formed in front wall 32 for releasably retaining a selected two of inserts 72, 74, and 76 in that wall. As seen in FIG. 21, two recesses 84 are also formed in rear wall 38 for releasably retaining a selected two inserts 72, 74, and 76 in that wall. FIG. 14A is a detailed cross-sectional view of a portion 100 of the carrier 10′ and object 20. FIG. 14A is an enlarged view of one of the recesses 84 formed in wall 38 of carrier 10′ with the ridge 82 of insert 74 seated in this recess.

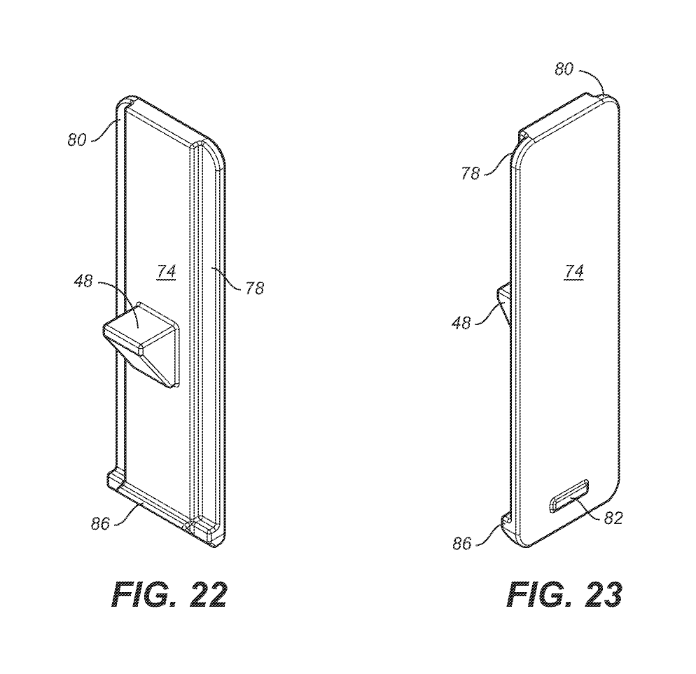

FIG. 22 is perspective view of the front of a latching pin insert 74 according to one embodiment of the invention, and FIG. 23 is a perspective view of the back of latching pin insert 74 shown in FIG. 22. As seen in FIG. 22, latching pin 48 is mounted on the front surface of insert 74. Elongated fingers 78 and 80 are formed on each side of insert 74. A ledge 86 is formed on one end of insert 74 to facilitate a user grasping the insert 74 for removal and insertion of insert 74 into one set of tracks 62, 64 in housing 30.

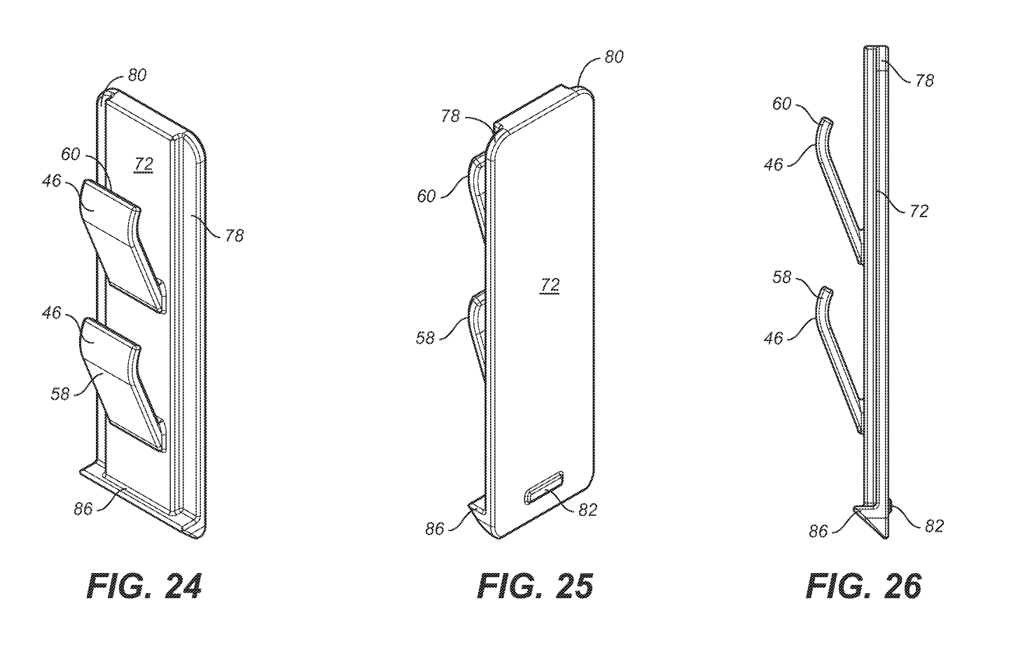

FIG. 24 is a perspective view of the front of a biasing member insert 72 according to one embodiment of the invention, FIG. 25 is a perspective view of the back of the biasing member insert 72 shown in FIG. 24, and FIG. 26 is a side view of the biasing member insert 72 shown in FIG. 24. As seen in FIG. 24, biasing member 46 is mounted on the front surface of insert 72. Elongated fingers 78 and 80 are formed on each side of insert 72. A ledge 86 is formed on one end of insert 72 to facilitate a user grasping the insert 72 for removal and insertion into one set of tracks 62, 64 housing 30.

As seen in FIGS. 20 and 21, spacers 50 and 52 have the same elongated fingers 78 and 80 as well as a ridge (not shown) for mating with a recess 84 to provide a detent for retaining each spacer on a respective wall 32, 38 of housing 30.

It should be understood that the foregoing description is only illustrative of the invention. Various alternatives and modifications can be devised by those skilled in the art without departing from the invention. In addition, many suitable sizes and shapes or type of elements or materials could be used. Accordingly, the present invention is intended to embrace all such alternatives, modifications and variances which fall within the scope of the invention as claimed.

What is claimed is:

1. A carrier for releasably securing an object, said object having an aperture or the like formed on one surface of the object, comprising:
a housing having four walls and defining an opening at one end for receiving said object;
a first biasing member positioned on the interior surface of a first one of said walls of said housing; and
a first latching pin positioned on the interior surface of the wall of said housing opposite to the wall on which said first biasing member is positioned, said first latching pin operable to mate with said aperture when said object is inserted into the housing, said first biasing member operable to apply a force against the adjacent surface of said object to cause said first latching pin to seat in said aperture to releasably retain said object in said housing, a portion of said object extending from said housing when said object is releasably retained in said housing for enabling an external force to be applied to said object to counteract the force applied by said first biasing member to enable disengagement of said first latching pin and removal of said object from said housing.

2. The carrier of claim 1, wherein said first biasing member is offset a predetermined distance from the axis of insertion of said housing and opposite to said first latching pin, such that removal of said object from said housing is enabled with the application of a twisting torque in the opposite direction to the force applied to said object by said first biasing member.

3. The carrier of claim 1 further comprising one or more spacers positioned on at least one of said first and opposite walls offset a predetermined distance from the axis of insertion of said housing in a direction opposite to said first biasing member and said first latching pin.

4. The carrier of claim 1, wherein said first biasing member is a leaf spring.

5. The carrier of claim 1, wherein said first biasing member is a plurality of leaf springs, wherein each spring is positioned to apply a force against said object at a different point along the surface of said object.

6. The carrier of claim 1, wherein said first biasing member is removably attached to the interior surface of said first wall, and wherein said latching pin is removably attached to the interior surface of said wall opposite to said first wall.

7. The carrier of claim 5, wherein the interior surfaces of said first wall and said wall opposite to said first wall each include two sets of opposed parallel tracks formed by three rails, and wherein said first biasing member and said first latching pin are inserts, wherein each insert includes elongated fingers along each side that are sized to slidably fit in one of said sets of parallel tracks formed by said rails.

8. The carrier of claim 7, wherein each said insert is retained on a respective said wall by a detent comprising a ridge formed on the rear surface of said insert and a corresponding recess formed in the surface of said wall.

9. The carrier of claim 7 further comprising a spacer insert for removable attachment to one or both of said first wall and said wall opposite to said first wall to provide a secure fit in said housing for said object while said object is being retained by said first latching pin, first biasing member, and said aperture formed in said object.

10. The carrier of claim 9, wherein each said spacer insert includes elongated fingers along each side that are sized to slidably fit in one of said sets of parallel tracks formed by said rails.

11. The carrier of claim 1 further comprising a second biasing member positioned on the interior surface of said wall opposite to said first wall and a second latching pin formed on the interior surface of said first wall and positioned to mate with an aperture formed in said object to enable the object to be releasably secured in said housing when the object is inserted into said housing in an opposite orientation.

12. The carrier of claim 11, wherein said first biasing member comprises a plurality of first leaf springs and said second biasing member comprises a plurality of second leaf springs, and wherein said first leaf springs are positioned to contact said object at different points along a first surface of said object, and wherein said second leaf springs are positioned to contact a second surface of said object opposite to said first surface at different points along said second surface of said object.

13. A carrier for releasably securing an object, said object having an aperture or the like formed on one surface of the object, comprising:
a housing having four walls and defining an opening at one end for receiving said object;
a first biasing member positioned on the interior surface of a first one of said walls of said housing offset a predetermined distance from the axis of insertion of said housing; and
a first latching pin positioned on the interior surface of the wall of said housing opposite to the wall on which said first biasing member is positioned, said first latching pin offset the same distance from said axis of insertion of said housing and operable to mate with said aperture when said object is inserted into the housing, said first biasing member operable to apply a force against the adjacent surface of said object to cause said first latching pin to seat in said aperture to releasably retain said object in said housing, a portion of said object extending from said housing when said object is releasably retained in said housing for enabling an external twisting force to be applied to said object in a direction opposite to the direction of the force applied by said first biasing member to counteract the force applied by said biasing member to enable disengagement of said first latching pin and removal of said object from said housing;
wherein said first biasing member is removably attached to the interior surface of said first wall, and wherein said latching pin is removably attached to the interior surface of said wall opposite to said first wall.

14. The carrier of claim 13, wherein the interior surfaces of said first wall and said wall opposite to said first wall each include two sets of opposed parallel tracks formed by three rails, and wherein said first biasing member and said first latching pin are inserts, wherein each insert includes elongated fingers along each side that are sized to slidably fit in one of said sets of parallel tracks formed by said rails.

15. The carrier of claim 14, wherein each said insert is retained on a respective said wall by a detent comprising a ridge formed on the rear surface of said insert and a corresponding recess formed in the surface of said wall.

16. The carrier of claim 13 further comprising a second biasing member positioned on the interior surface of said wall opposite to said first wall and a second latching pin formed on the interior surface of said first wall and positioned to mate with an aperture formed in said object to enable the object to be releasably secured in said housing when the object is inserted into said housing in an opposite orientation.

17. A method for releasably securing an object in a carrier having a housing that includes four walls and defining an opening at one end for receiving said object and a latching pin positioned on the interior surface of a first one of said walls of said housing, comprising:
positioning said object in said housing such that an aperture on a first surface of said object mates with said latching pin;
applying a biasing force to a second surface of said object that is on the opposite side of said first surface to cause said latching pin to remain securely seated in said aperture; and
applying an external twisting force to said object in a direction opposite to the force applied to said second surface, to cause said latching pin to disengage from said aperture and release said object.
